(19) United States
(12) Patent Application Publication
(10) Pub. No.: US 2007/0005158 A1
(43) Pub. Date: Jan. 4, 2007

(54) Web based controller

(75) Inventors: Edward Nicolson, San Francisco, CA (US); David Ma, Mountain View, CA (US); Craig Latimer, Berkeley, CA (US); Ryan Findley, San Jose, CA (US)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KABUSHIKI KAISHA YASKAWA DENKI, Kitakyushu-shi (JP)

(21) Appl. No.: 11/170,082

(22) Filed: Jun. 30, 2005

(51) Int. Cl. G05B 11/32

(52) U.S. Cl. 700/69

(57) ABSTRACT

The invention described in this patent is a motion control system hierarchy where all the components are connected by a two way communication link, which gives the system an ability to transfer data from all levels of the hierarchy up to a PC to be viewed and/or modified. Further, the user interface to the motion control system hierarchy is a ubiquitous web browser obviating the need for additional software installation on the PC. By interfacing through a web browser and adding a embedded web server to the motion controller, the communication protocol is fixed but the format of the communication remains flexible. The invention also uses the Extensible Markup Language (XML) as a means for keeping the interface between the PC and the motion controller as flexible as possible. Among the uses of XML in this invention are as a tool for configuration, data sharing, and for remote procedure calls.

### FIELD OF INVENTION

This invention relates to the field of motion control in industrial applications. Specifically, it describes an open hierarchy of components that are required to control axes of motion and a means of interfacing with and controlling the axes of motion by means of a web browser on a client computer.

### BACKGROUND OF THE INVENTION

A machine requiring motion control in industrial applications may include many system components such as axes of motion, motor drives, motion controllers, I/O modules, and in many cases a PC that interfaces with the motion control system. In a typical hierarchy the motion controller, which has a stored program and a CPU or DSP to execute the programs, sends a digital or analog command to the motor drive. The motion controller may have control over multiple axes of motion as well as I/O, digital/analog inputs and outputs. It may also be connected a PC via a hardware bus or network connection.

The motion drive receives a command from the motion controller and energizes an axis of motion. A drive might be a simple power amplifier which energizes the axis of motion in response to analog commands, or it might also have some intelligence such as a DSP. An axis of motion performs the actual motion in the machine. Examples of axes of motion include AC servo motors, linear motors, and stepper motors, etc. The axis of motion may also have intelligence in the form of a processor located inside a motor. In any machine, such as one for the semiconductor industry, a large number of motion control components may be used and the components used may vary greatly depending on the manufacturer, the application requirements, and the component interface. It is not unusual for a machine builder to integrate different components from different vendors.

In many cases, since the motion controller has stored programs and a processor, the entire motion control system can function without any user interface. However, some type of user interface is required for certain operations such as system configuration, firmware updates, data logging and display of real-time data, stored program development, system debugging, and simple operations. To interface with this hierarchy of motion control components a PC is typically used. The connection of the PC to the motion controller is a hardware bus such as PCI, ISA, or VME, or a network connection such as Ethernet, USB.

System configuration includes setting up the motion control system and diagnostics. Setup involves receiving, storing, changing, acting on and displaying configuration data stored in system components. Updating firmware involves downloading new software from the PC to systems components down the motion control hierarchy. Downloading new firmware may be done to add software features to the component or it may be done to fix software bugs.

In the motion control system there are certain cycles that are executed at deterministic intervals. These are real-time cycles. Data logging allows real-time monitoring of user selectable variables and graphical displays of the data. Logging may take place on a once per cycle basis or on submultiples of a real-time cycle.

Stored program development includes modifying, debugging, and executing programs. System debugging includes indicating alarm conditions inside system components and other event notification. Finally, simple operations are user commanded movements by the axes of motion.

On a typical PC there is no native software for communication with the motion control system previously described. For example, customers cannot simply connect a laptop computer to a network and begin communicating with the motion control system. Vendors and customers now follow a standard procedure when developing applications for the motion control system. First, customers use vendor-supplied software, which has to be installed on the PC first, to communicate with the motion control system, perform initialization, and send simple commands to the axes of motion. Next, the stored programs on the motion controller are developed. These stored programs are created using high level programming languages like C, Java, Visual Basic, vendor-specific scripting languages, ladder programs, or graphical-based programming using icons. After being written the stored programs are downloaded to the motion controller, tested and then stored in nonvolatile memory. If a different computer is used anywhere in this chain of events, the vendor-supplied software has to be reinstalled. Also, if the vendor changes the motion controller firmware such that it becomes incompatible with software installed on the PC, then the PC software also must be reinstalled.

Another issue with the current motion control hierarchy is configuration. In a motion control system the axis of motion, motion drive, and motion controller combined may have hundreds of different parameters to record and/or change, such as maximum rate speed of the motor and maximum current rating of the motion drive. This configuration is difficult for several reasons. First, if each component is supplied by a different vendor then it is difficult to communicate information correctly up to the PC, and in some cases impossible. For example, an axis of motion, such as an AC motor, may have configuration parameters stored in nonvolatile memory. If it is then connected to motion drive without the capability to communicate with it, these configuration parameters are lost because they cannot be sent up the motion control system hierarchy. A typical connection between a motion drive and axis of motion is a simple analog connection not meant for communicating data. For instance, an amplifier connected to an AC servo motor may have only a connection to energize the motor phases and one for encoder feedback. In this situation, the motion drive and the rest of the motion control hierarchy loses the configuration data on the AC servo motor.

Second, there is a question of where the format and display of the configuration data is specified. If it is handled by the vendor-supplied software on the PC, then in most cases it becomes fixed. Changes in format are difficult to make on-the-fly. For example, if the format and content of the configuration data from a motion controller were to be changed, it is impossible for the software on the PC to display the data correctly because its knowledge of the data format is fixed. In other words, if more features were added to the motion controller's firmware that included additional configuration data, the older version of PC software may not be able to handle the data correctly. To display the data correctly, an updated version of the vendor-supplied software would have to be installed on the PC. Another example where a fixed format can cause problems is foreign language support. It is now a common requirement to install a new version of the PC software if support for another language is required, such as switching from English language to Japanese language.

This lack of component integration and PC software flexibility can lead to operational error and safety hazards. For instance, if the axis of motion stores maximum torque output information locally in its nonvolatile memory, this configuration data can be used at the top of the motion control hierarchy to monitor commands send back down to the motion drive. Another example is that the scientific units for the data stored on the motion controller could change between firmware versions without recognition from the PC software. One firmware version on a motion controller might represent axis of motion acceleration as m/s² while a newer version might represent it as mm/s² or encoder counts/ s².

For the reasons outlined above, there is need for a motion control system hierarchy that is well-integrated, in the sense that there should be a two-way path of communications between each of the system components. Further, it is desirable that each system component should have some form of nonvolatile memory such as Flash memory, EEPROM or a simple ROM. The nonvolatile memory will contain and accept configuration data about the system component. In addition, there should be method of interfacing the PC with the motion control system hierarchy that does not require additional software that is not a part of its normal operating system. For example, a x86 computer running Windows 2000 would be all that is required to communicate with the motion control system.

### SUMMARY OF THE INVENTION

The invention described below is a motion control system hierarchy where all the components previously mentioned are connected by a two way communication link, which gives the system an ability to transfer data from all levels of the hierarchy up to a PC to be viewed and modified. Further, the user interface to the motion control system hierarchy is performed by an ubiquitous web browser obviating the need for additional software installation on the PC. To address the issues described above, many Internet-related technologies are applicable. To begin, all new Windows operating system, such as Windows 2000, come with a version of Internet Explorer, a web browser. Embedded web servers are also becoming common in everyday life. In this invention, the web browser's capabilities are used as the basis for communication between the PC and the motion controller. As mentioned before, one disadvantage of interfacing a PC with the motion control hierarchy is that vendor-specific software must be installed. This may lead to tedious software reinstallation whenever components change or software updates are done.

By interfacing through a web browser and adding a embedded web server to the motion controller, the communication protocol is fixed but the format of the communication remains flexible. The invention also uses the Extensible Markup Language (XML) as a means for keeping the interface between the PC and the motion controller as flexible as possible. Among the uses of XML in this invention are as a tool for configuration, data sharing, and for remote procedure calls.

In the preferred embodiment of the invention, the PC is part of a network that may include one or more motion controllers. Each motion controller has an embedded web server and its own separate IP address. For the PC to communicate with one of the motion controllers on a LAN, the only requirement is that the motion controller's IP address is known. The method of connection between the motion controller and motion drive may be an Ethernet connection, but may also be another type of high speed network connection such as IEEE 1394 or USB. A motion controller is also connected to one or more motion drives, which are each attached to one axis of motion. The preferred method of connection between the motion controller and motion drives is a real-time network connection such as but not limited to DeviceNet, Yaskawa's Mechatrolink, SERCOS, or an IEEE 1394 connection.

A key element of the implementation is a high speed two way communication link between the motion controller and the motion drive. This communication link and communication protocol will expose configuration data up to the higher levels of the motion control hierarchy and also allow the data to be changed and stored in motion drive's nonvolatile memory. Motion drives may be separate drive modules, or they may be multiple axis drives (MAD). Each motion drive is connected to an axis of motion. Or, in the case of a MAD, multiple axes of motion. Again, there is a two way communication link between these two system components which allows for the transfer and adjustment of configuration data stored on the axis of motion. There are currently no widespread industry standards for linking the axis of motion to the motion drive. However, Yaskawa has a high speed serial link between the motion drives and a processor inside the axis of motion.

### BRIEF DESCRIPTION OF THE DRAWINGS

FIG. 1 is a drawing of the motion control hierarchy;

FIG. 2 is a drawing of multiple motion controllers connected to one PC; and

FIG. 3 is a drawing of the software architecture on the motion controller and the browser on the PC.

### DETAILED DESCRIPTION OF THE INVENTION

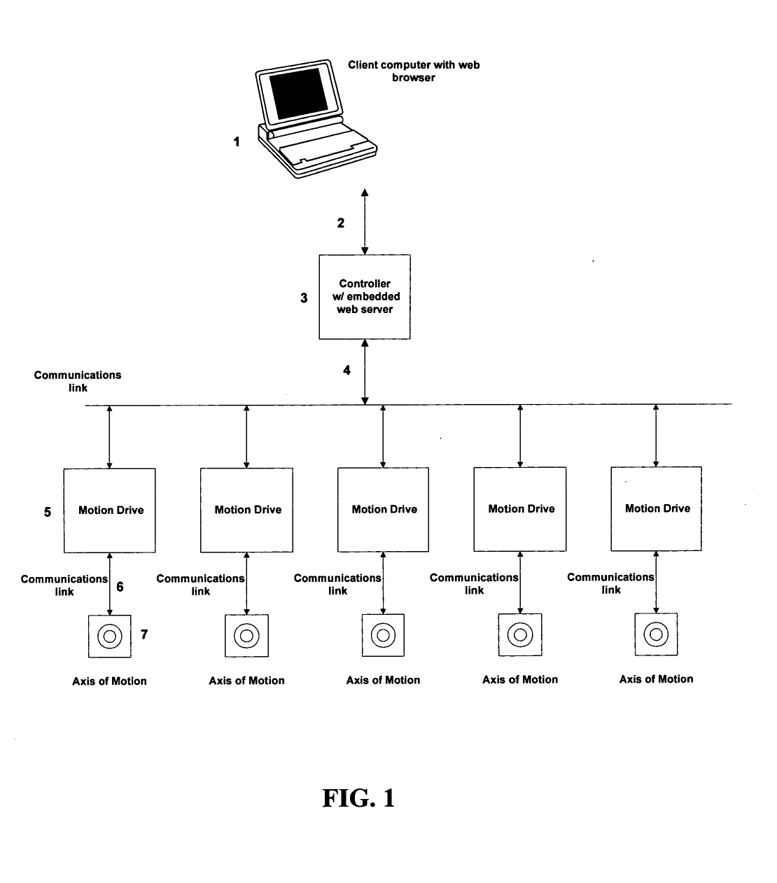

FIG. 1 shows an example of the motion control system hierarchy. At the top of the hierarchy is the PC with a web browser 1. The PC is connected to a motion controller 3 with an embedded web server via a high speed network connection 2. The network connection may be a standard Ethernet connection, but could also be any other applicable high speed connection such as IEEE 1394 or USB. The motion controller, in turn, is connected to multiple motion drives 5 via a real-time network 4. At the bottom of the hierarchy are the axes of motion 7, also connected via a high speed connection 6. Although not shown, the motion drives may be MADs, where each motion drive would have multiple axes of motion connected to it.

At system startup, the hierarchy undergoes discovery where the motion controller must discover information about the motion drives and axes of motion connected to it. It clear from this figure that in order for the discovery to take place, there must be two way communications links in order for data from all the system components to reach the motion controller. The process of retrieving data from all levels of the hierarchy and sending the data to the top of the hierarchy, while only requiring a web browser on the PC, is a key advantage of the invention.

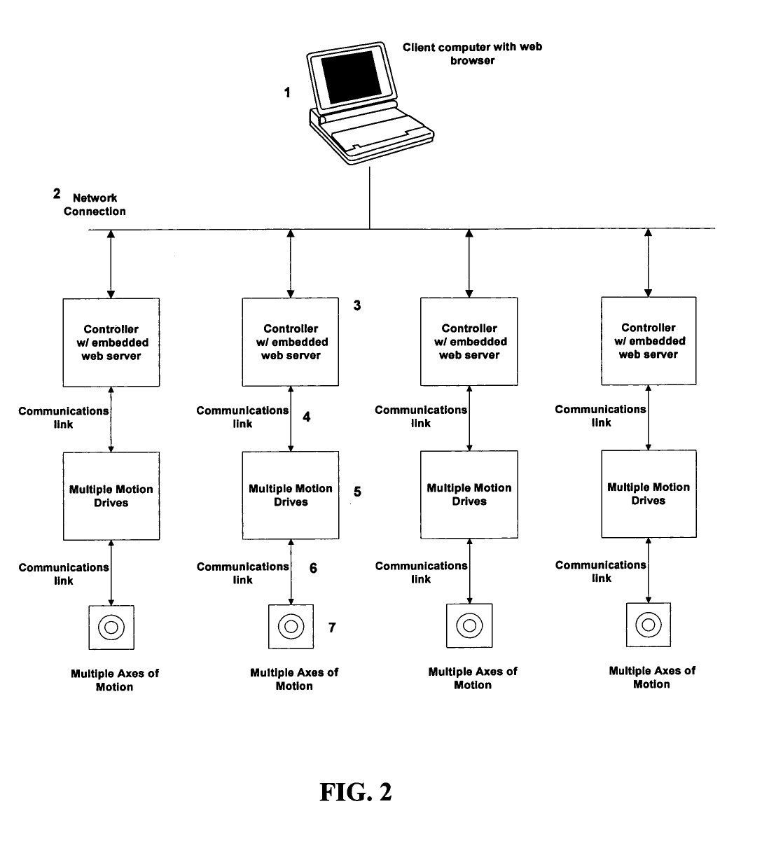

FIG. 2 shows an example of multiple motion controllers 3 connected to the PC 1. Otherwise, the motion control system hierarchy is similar to the one described in FIG. 1.

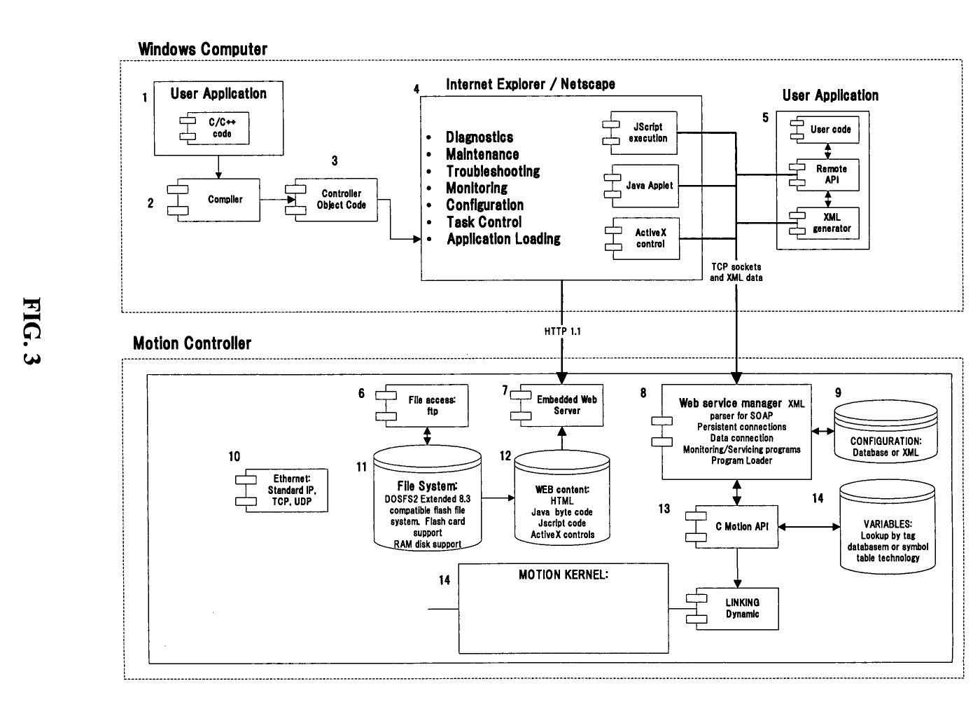

FIG. 3 shows the software architecture with the Widows computer in the top window and the motion controller in the bottom window. Controller object code, written in C/C++1 and compiled 2 outside the web browser environment 3, can be downloaded through the web browser interface. The download uses the ftp server 6 on the motion controller. The web browser 4 is used for diagnostics, monitoring real-time data, configuration, command interface, and application loading. Diagnostics involves but is not limited to operations such as reading and writing to memory on the motion controller, monitoring I/O, and alarm/event handling.

Monitoring real-time data involves recording cyclic data from any component in the motion control system hierarchy. Data could be standard feedback such as position or velocity of an axis of motion, or it could be any user-selected variable of interest. The format of the data could be in XML or another format. If XML is used, then the motion controller can specify how to display or handle the data via Extensible Markup Language Templates (XSLT). Transferring the data in XML format is advantageous because the format of the data becomes highly flexible. This is because the PC does not need to know anything about the data prior to receiving it. When it receives the XML file from the motion controller, the browser could be instructed to also retrieve a XSLT file from the motion controller, which will have instructions on how to handle the data.

Configuration of the motion control hierarchy could also involve XML. Prior to the PC interfacing with the motion control system hierarchy, the motion controller has performed a discovery of everything connected to it and has gathered and stored configuration data received from its motion drives and axes of motion. Now this data can be transferred and displayed by the web browser. In this way, configuration data from the bottom of the motion control system hierarchy can be transferred up to the highest level, the web browser on the PC, to be viewed and changed by the user. Again, if the data is transferred to the PC in XML format, then the XSLT file can be used to specify to the web browser how the data is to be handled. The format is flexible and can change without reinstalling new software on the PC.

The web browser can also be used as a command interface with the motion controller. This interface can be used to call remote API on the motion controller. Remote API are stored program routines that already exist on the motion controller. Another option is to download user code 5 that call the remote API. This could be in the form of script to be interpreted by the motion controller. One option for calling remote API from the web browser is to use Simple Object Access Protocol (SOAP) Remote Procedure Calls (RPC) utilizing the HTTP 1.1 protocol. The RPC are in XML format and parsed by an XML parser on the embedded web server.

The web browser also runs Java Applets, ActiveX controls, and Java Scripts (JScript) served up by motion controller. Java Applets and Active X controls can be used for monitoring real-time data, and Jscripts are used in many situations including converting XML to HTML. Again, this code is served up by the motion controller and the only requirement on the PC is to have a web browser.

The protocol for communications between the PC and the motion controller is Hypertext Transfer Protocol (HTTP) 15 over which web content is served, and TCP sockets 16 over which XML data and other data is transferred during real-time data monitoring and RPCs. On the motion controller, there is an File Transfer Protocol (FTP) server 6, which has access to the flash file system 11. Also on the motion controller is an embedded web server 7, which serves up web content 12 including HTML files, Java byte code, Jscripts, and ActiveX controls. The web service manager contains a XML parser for, and connects to the C Motion API during RPCs and the configuration file storage. The motion kernel 14 is the engine for motion control tasks, real-time calculations, and communication with the motion drives.

What is claimed is:

1. A motion controlling system, comprising following system elements:
at least one stand alone motion controller having software architecture including an embedded web server;
motion drives capable of moving one or more axes of motion, said motion drives communicating with said motion controller; and
at least one client computer from which communication and control of said motion controller can be performed through a web browser.

2. The motion controlling system according to claim 1 wherein said software architecture of the motion controller includes a Real Time Operating System (RTOS) for implementing real-time routines.

3. The motion controlling system according to claim 2 wherein, said real-time routines take place at deterministic time intervals of axis of motion position update at 16 kHz.

4. The motion controlling system according to claim 1, wherein said software architecture of said motion controller includes a flash file system for file storage.

5. The motion controlling system according to claim 1, wherein said software architecture of said motion controller includes a File Transfer Protocol (FTP) server for file transfer.

6. The motion controlling system according to claim 1, wherein said software architecture of said motion controller includes an embedded web server capable of communicating with a web browser via Hypertext Transfer Protocol (HTTP).

7. The motion controlling system according to claim 1, wherein said software architecture of said motion controller includes TCP sockets for web services and Simple Object Access Protocol (SOAP) Remote Procedure Calls (RPC).

8. The motion controlling system according to claim 1, wherein said software architecture of said motion controller includes any one of stored Java bytecode, Javascript, or ActiveX code.

9. The motion controlling system according to claim 1, wherein said software architecture of said motion controller stores configuration files in Extensible Markup Language (XML) format.

10. The motion controlling system according to claim 1, wherein said software architecture of said motion controller includes an XML parser which interprets XML documents.

11. The motion controlling system according to claim 1, wherein said software architecture of said motion controller includes remote API for executing C code on the motion controller from the web browser.

12. The motion controlling system according to claim 1, wherein said web browser in said client computer in said client computer performs all tasks specified below without additional software on said client computer other than the web browser.

13. The motion controlling system according to claim 1, wherein said web browser in said client computer sends and/or receives data to any system component.

14. The motion controlling system according to claim 13, wherein data is sent and/or received in said client computer via HTTP or TCP sockets in the form selected from HTML, XSL and XML files.

15. The motion controlling system according to claim 1, wherein said web browser in said client computer receive real-time data logged continuously from any system element and update the web browser's Graphical User Interface (GUI).

16. The motion controlling system according to claim 15, wherein said client computer has persistent TCP sockets and Java Applets or ActiveX control on the PC.

17. The motion controlling system according to claim 1, wherein said web browser of said client computer performs configuration by receiving and parsing XML files served up by the motion controller's embedded web server.

18. The motion controlling system according to claim 17, wherein configuration is changed by sending XML files to said motion controller.

19. The motion controlling system according to claim 1, wherein said web browser of said client computer conduct remote procedure calls using a set of remote Application Interfaces (API) to execute code stored on the motion controller of claim 1.

20. The motion controlling system according to claim 19, wherein remote procedure calls could be done using SOAP which are in XML format.

21. The motion controlling system according to claim 1 wherein said web browser of said client computer updates firmware stored in the nonvolatile memory of any system element.

22. The motion controlling system according to claim 21, wherein said firmware can be downloaded from the client computer or from another location on the internet.

23. The motion controlling system according to claim 1 wherein said web browser of said client computer uses the web browser interface as a development environment to program and debug a command sequence for said motion controller using the remote API.

24. The motion controlling system according to claim 1 wherein any one of said system elements is connected by two way communication links, whereby data can be sent and retrieved by all levels of the motion control system hierarchy and be viewed and manipulated inside a web browser on the PC.

25. The motion controlling system according to claim 1 wherein any one of said system elements have nonvolatile memory selected from Flash, EEPROM, or battery backed up RAM, which contains data such as component information and/or configurable data.
